(19) United States
(12) Patent Application Publication
(10) Pub. No.: US 2026/0332967 A1
(43) Pub. Date: Oct. 22, 2026

(54) HEARING SYSTEM CONTAINING A HEARING INSTRUMENT AND A METHOD FOR OPERATING THE HEARING INSTRUMENT

(71) Applicant: Sivantos Pte. Ltd., Singapore (SG)

(72) Inventors: Maja SERMAN, Erlangen (DE); Cecil WILSON, Erlangen (DE); Marko LUGGER, Erlangen (DE)

(21) Appl. No.: 19/408,483

(22) Filed: Dec. 4, 2025

(30) Foreign Application Priority Data
Feb. 24, 2025 (EP) 25 159 737.3

(51) Int. Cl. H04R 25/00; G10L 21/0364

(52) U.S. Cl. CPC H04R 25/356; G10L 21/0364; H04R 2225/39; H04R 2225/41; H04R 2225/43; H04R 2430/01

(57) ABSTRACT

A hearing system has a hearing instrument to be worn in or at an ear of a user and a method for operating the hearing instrument. During operation of the hearing instrument, a sound signal from an environment of the hearing instrument is captured and processed to support the hearing of the user. The processed sound signal is output to the user. In an onset recognition step of the signal processing, the captured sound signal is analyzed to recognize onsets of spoken phonemes. In an onset enhancement step, the processed sound signal is momentarily modified, when an onset of a spoken phoneme is recognized, to enhance the onset. Herein, the processed sound signal is momentarily modified by selectively increasing the signal level of the processed sound signal in a first frequency sub-range.

### CROSS-REFERENCE TO RELATED APPLICATION

This application claims the priority, under 35 U.S.C. § 119, of European Patent Application EP 25 159 737.3, filed Feb. 24, 2025; the prior application is herewith incorporated by reference in its entirety.

### FIELD AND BACKGROUND OF THE INVENTION

The invention relates to a method for operating a hearing instrument. The invention further relates to a hearing system containing a hearing instrument.

Generally, a hearing instrument is an electronic device configured to support the hearing of a person wearing it (which person is called the user or wearer of the hearing instrument). In particular, the invention relates to hearing aids, i.e., hearing instruments that are specifically configured to at least partially compensate a hearing impairment of a hearing-impaired user.

Hearing instruments are most often designed to be worn in or at the ear of the user, e.g., as a Behind-The-Ear (BTE) or In-The-Ear (ITE) device. With respect to its internal structure, a hearing instrument normally contains an (acousto-electrical) input transducer, a signal processor, and an output transducer. During operation of the hearing instrument, the input transducer captures a sound signal from an environment of the hearing instrument and converts it into an input audio signal (i.e., an electrical signal transporting a sound information). In the signal processor, the input audio signal is processed, in particular amplified dependent on frequency, e.g., to compensate the hearing-impairment of the user. The signal processor outputs the processed signal (also called “output audio signal”) to the output transducer. Most often, the output transducer is an electro-acoustic transducer (also called “receiver”) that converts the output audio signal into a processed air-borne sound which is emitted into the ear canal of the user. Alternatively, the output transducer may be an electro-mechanical transducer that converts the output audio signal into a structure-borne sound (vibrations) that is transmitted, e.g., to the cranial bone of the user. Furthermore, besides classical hearing instruments, there are implanted hearing instruments such as cochlear implants, and hearing instruments the output transducers of which directly stimulate the auditory nerve of the user. Other hearing instruments (sometimes referred to as “Personal Sound Amplification Products”) are designed to support the hearing of normal-hearing users (i.e., users without hearing impairment), in particular to protect the hearing in harmful sound environments or to allow for better speech perception in complex background noise.

The term “hearing system” denotes one device or an assembly of devices and/or other structures providing functions required for or supporting the operation of a hearing instrument. A hearing system may consist of a single stand-alone hearing instrument. As an alternative, a hearing system may comprise a hearing instrument and at least one further electronic device which may, e.g., be one of another hearing instrument for the other ear of the user, a remote control, and a programming tool for the hearing instrument. Moreover, modern hearing systems often comprise a hearing instrument and a software application for controlling and/or programming the hearing instrument, which software application is or can be installed on a computer or a mobile communication device such as a mobile phone (smart phone). In the latter case, typically, the computer or the mobile communication device are not a part of the hearing system. In particular, most often, the computer or the mobile communication device will be manufactured and sold independently of the hearing system.

A typical problem of hearing instrument users is bad speech understanding. Parts of these problems are caused by the fact that any hearing instrument alters or disturbs the natural sound to some extent, as a consequence of damping and/or signal processing by the hearing instrument. Thus, although the sound provided to the user may be amplified by the hearing instrument, as compared to the original ambient sound, information normally used by the human hearing (such as spectral cues, fast amplitude variations of the ambient sound, or slight binaural amplitude differences or delays) may get lost. Thus, even normal-hearing users of hearing instruments may experience problems with understanding speech when wearing the hearing instrument. For hearing-impaired people, bad speech understanding is often exacerbated by the pathology of the inner ear resulting in an individual reduction of the dynamic range of the hearing-impaired person. This means that soft sounds become inaudible to the hearing-impaired listener (particularly in noisy environments) whereas loud sounds retain their loudness levels. In this case, often the problem of bad speech understanding cannot be overcome satisfactorily by simply increasing amplification, as this may lead to overloud sound peaks in the processed sound causing discomfort to the user.

The reduced dynamic range of the hearing-impaired user is often compensated using compression, i.e. the amplitude of the input signal is increased as a function of the input signal level. However, commonly used implementations of compression in hearing instruments often result in various technical problems and distortions due to the real time constraints of the signal processing. Moreover, in many cases, compression is not sufficient to enhance speech perception to a satisfactory extent.

A method for operating a hearing aid and a hearing system containing a hearing instrument are disclosed in published, European patent application EP 3 823 306 A1, corresponding to U.S. Pat. No. 11,510,018. Herein, a sound signal from an environment of the hearing instrument is captured and processed to at least partially compensate the hearing-impairment of the user. The processed sound signal is output to the user. The processing comprises analyzing the captured sound signal to recognize onsets of spoken phonemes, and momentarily modifying the processed sound signal, when an onset of a spoken phoneme is recognized, to enhance the onset. More precisely, the captured sound signal is analyzed to recognize speech intervals, in which the captured sound signal contains speech. During recognized speech intervals, at least one time derivative of an amplitude and/or a pitch of the captured sound signal is determined; and the amplitude of the processed sound signal is momentarily increased, if the at least one derivative fulfills a predefined criterion. While this method and system can effectively improve speech understanding, it was found to have a negative influence on sound quality, in some situations. Thus, using this method and system requires a precarious compromise to be made between improved speech understanding and sound quality cost to achieve a satisfying overall benefit.

### SUMMARY OF THE INVENTION

An object of the present invention is to provide a method for operating a hearing instrument being worn in or at the ear of a user which method provides improved speech perception and satisfying sound quality to the user of the hearing instrument. Another object of the present invention is to provide a hearing system with a hearing instrument to be worn in or at the ear of a user, which system provides improved speech perception and satisfying sound quality to the user of the hearing instrument.

According to a first aspect of the invention, a method for operating a hearing instrument to be worn in or at an ear of a user is provided. Preferred embodiments of the method are defined in the dependent claims and in the subsequent description.

With the foregoing and other objects in view there is provided, in accordance with the invention, a method for operating a hearing instrument configured to be worn in or at an ear of a user. The method includes capturing a sound signal from an environment of the hearing instrument and processing a captured sound signal to support a hearing of the user. The processing of the captured sound signal includes performing an onset recognition step in which the captured sound signal is analyzed to recognize onsets of spoken phonemes, and performing an onset enhancement step by momentarily modifying a processed sound signal, when an onset of a spoken phoneme is recognized, to enhance the onset. The processed sound signal is momentarily modified by selectively increasing a signal level of the processed sound signal in a first frequency sub-range. The processed sound signal is then output to the user.

The method includes capturing a sound signal from an environment of the hearing instrument, e.g., by an input transducer of the hearing instrument. The captured sound signal is processed, e.g., by a signal processor of the hearing instrument, to support the hearing of the user, thus producing a processed sound signal. The processed sound signal is output to the user, e.g., by an output transducer of the hearing instrument. In the preferred implementation, the captured sound signal and the processed sound signal, before being output to the user, are audio signals, i.e. electric signals transporting sound information.

The hearing instrument may be of any type as specified above. Preferably, it is designed as a BTE hearing instrument (with internal or external receiver) or as an ITE hearing instrument. Alternatively, the hearing instrument may be designed as an implantable hearing instrument. The processed sound signal may be output as air-borne sound, as structure-borne sound or as a signal directly stimulating the auditory nerve of the user.

Preferably, the hearing instrument is a hearing aid that is specifically designed to address the needs of a hearing-impaired user. In this case the signal processing is configured to at least partially compensate the hearing-impairment of the user. However, the method can also be applied with benefit to hearing instruments for normal-hearing users to improve speech understanding of the latter when wearing the hearing instrument.

The processing of the captured sound signal comprises, in an onset recognition step of the method, analyzing the captured sound signal to recognize onsets of spoken phonemes. In an onset enhancement step of the method, the processed sound signal is momentarily modified, when an onset of a spoken phoneme is recognized, to enhance the onset. Herein, momentarily modifying the processed sound signal means that the modification is applied for a short time interval (enhancement time) only and that the modification is undone thereafter. Preferably, this enhancement time is between 5 to 15 msec, in particular 10 msec, corresponding to the recognized onset of a spoken phoneme.

According to the present invention, in the onset enhancement step of the method, the processed sound signal is momentarily modified by selectively increasing the signal level (i.e., increasing amplification) of the processed sound signal in a first frequency sub-range. Herein and subsequently, the term “frequency sub-range” denotes a range of frequencies being comprised in but smaller than the entire frequency range of the captured or processed sound signal. The term “selectively” denotes a limitation to the mentioned frequency sub-range. Hence, different from the method and system known from European patent application EP 3 823 306 A1, the momentary increase of the signal level of the processed sound signal is limited to the first frequency sub-range. In other words, the signal level is not momentarily increased for spectral portions of the processed sound signal having frequencies outside the first frequency sub-range.

It has been found that, by limiting the momentary increase of the signal level to a certain frequency sub-range of the processed audio signal, onsets of spoken phonemes can be enhanced in a highly effective manner that significantly improves speech understanding for hearing-impaired and normal-hearing hearing instrument users. On the other hand, artefacts in the processed sound signal that would be induced by a momentary increase of the overall signal amplitude, as taught by European patent application EP 3 823 306 A1, can be significantly reduced (without having to pay for this with a deterioration of speech intelligibility). In other words, good speech intelligibility and good sound quality, in particular, a close-to-natural speech sound, can be achieved simultaneously.

While momentarily increasing the signal level of the processed sound signal in the first frequency sub-range may result in a momentary increase of the overall signal amplitude of the processed sound signal, this is not necessary for the method according to the invention. In contrast, in some embodiments of the invention, the momentary increase of the signal level of the processed sound signal in the first frequency sub-range, upon recognition of an onset of a spoken phoneme, is combined with a simultaneous decrease of the signal level (i.e. increase of damping) in at least one other spectral portion of the processed sound signal (outside the first frequency sub-range). Optionally, this momentary decrease of the signal level outside the first frequency sub-range is dimensioned so that it compensates the momentary increase of the signal level inside first the frequency sub-range, with respect to the overall signal amplitude of the processed sound signal. In other words, the overall signal amplitude of the processed sound signal may be kept unchanged (i.e. equal to the overall signal amplitude of the unenhanced processed sound signal) despite the momentary increase of the signal level inside the first frequency sub-range. Thus, a particularly effective onset enhancement can be achieved without risking overloud sound peaks that may cause discomfort to the user.

In a preferred embodiment of the method, in the onset recognition step of the method, recognition of onsets of spoken phonemes involves selectively analyzing the captured sound signal in a second frequency sub-range for fulfilling a predefined onset criterion. In other words, it is assessed whether a specific spectral portion of the captured sound signal corresponding to the second frequency sub-range fulfills the predefined onset criterion. Herein, again, the term “selectively” denotes a limitation to the mentioned frequency sub-range. Hence, only the spectral portion of the captured sound signal corresponding to second frequency sub-range is made subject to this analysis, whereas further spectral portions of the captured sound signal having frequencies outside the second frequency sub-range are not considered in this analysis. Herein, fulfilling the onset criterion in the second frequency sub-range is a necessary condition for onset recognition. Limiting the check for fulfillment of the onset criterion to a certain frequency sub-range has been found to be beneficial for achieving effective onset recognition with a reduced error probability, as compared to frequency-independent onset recognition. This results in improved sound quality as artefacts caused by wrong onset detection can be avoided.

Preferably, the second frequency sub-range (that is analyzed for onset recognition) is identical to the first frequency sub-range (to which the onset enhancement is applied). Thus, preferably, onset recognition and onset enhancement are limited to the same sub-range of frequencies. However, within the scope of the invention, the second frequency sub-range may slightly vary from the first frequency sub-range. Thus, first and second frequency sub-ranges may be similar instead of identical. In a suited approach, the first and second frequency sub-ranges are considered similar if the (absolute) difference of their respective (upper or lower) limits is smaller than 15% (more preferred smaller than 12.5%; still more preferred smaller than 10%) of the width of the first (or second) frequency sub-range; i.e., for example if |f_{1st,min}-f_{2nd,min}|<x·(f_{1st, max}-f_{1st,min}) and |f_{1st,max}-f_{2nd,max}|<x·(f_{1st, max}-f_{1st,min}); wherein f_{1st,min} and f_{1st,max} are the lower and upper limit of the first frequency sub-range, respectively; f_{2nd,min} and f_{2nd,max} are the lower and upper limit of the second frequency sub-range; and x is 15% (or 12.5%, or 10%).

In order to further increase efficiency of onset recognition of spoken phonemes and to further reduce the probability of false onset recognition, preferably, the onset recognition step involves selectively analyzing the captured sound signal in a third frequency sub-range for non-fulfillment of the predefined onset criterion, wherein a third frequency sub-range does not overlap with the second frequency sub-range. It is thus assessed whether a specific spectral portion of the captured sound signal corresponding to the third frequency sub-range fulfills the predefined onset criterion wherein non-fulfilling the onset criterion (i.e. failure to fulfill the onset criterion) in the third frequency sub-range is a further necessary condition for onset recognition. Again, the term “selectively” denotes a limitation to the mentioned frequency sub-range which, again, denotes a frequency range comprised in and smaller than the entire frequency range of the captured sound signal. Thus, only the spectral portion of the captured sound signal corresponding to the third frequency sub-range is made subject to this analysis. This embodiment considers the finding that the speech sound of spoken phonemes is limited to specific frequency ranges and does not extend over the entire audible frequency range. Thus, by checking certain frequency ranges outside the characteristic frequency ranges of spoken phonemes for non-fulfillment of an onset criterion, real onsets of spoken phonemes can be better distinguished from other sudden variations of the signal level in the captured sound signal.

The onset criterion reflects the fact that the onset of a spoken phonemes typically involves a positive step (i.e. a step-like increase or short-time increase) of the signal level or signal energy of the captured sound signal, at least at certain frequencies. Thus, in general, the onset criterion includes at least one indication for a step in the signal level or signal energy as it is typically induced by the onset of a spoken phoneme. In a preferred implementation of the method, the predefined onset criterion is defined such that it is fulfilled when, for the respective (second or third) frequency sub-range of the captured sound signal, a step of the signal level or signal energy having a step size exceeding a predefined (first) threshold is detected. In accordance with the general meaning of this term in the fields of signal processing and statistics, the term “step” (also referred to as “jump” or “shift”) denotes an abrupt change in the mean level (base line) of a time series or signal. Specifically, the term “step” denotes an abrupt increase of a signal level or signal energy of the captured sound signal in the respective (second or third) frequency sub-range. The term “step size” denotes the difference between the respective signal level or signal energy immediately before and after the step. Preferably, the step size is determined from a difference of a short-time average and a long-time average of the respective signal level or signal energy. In this case, e.g., the onset criterion may be considered fulfilled when the difference exceeds the (first) threshold. The short-time average and the long-time average may be acquired by applying two level meters with different time constants to the respective signal. Preferably, the short-time average is a calculated for time constant or temporal window size that is shorter than the duration of a spoken phoneme, in particular for a time constant of 5 msec to 20 msec, preferably 10 msec. In contrast, the long-time-time average is a calculated for time constant or temporal window size that is comparable to/longer than the duration of a spoken phoneme, in particular for a time constant of 75 msec to 250 msec, preferably 125 msec.

In further implementations of the method, additionally or alternatively to comparing a step size with a first threshold as described above, the predefined onset criterion may involve comparing a time derivative of the signal strength or signal energy in the respective (second or third) frequency sub-range of the captured sound signal with a (second) predefined threshold. This check may be defined according to the teaching of European patent application EP 3 823 306 A1.

Within the scope of the invention, an overall step size and/or an overall temporal derivative can be determined for the (second or third) frequency sub-range. In other words, the step size and/or the overall temporal derivative can be determined as scalar quantities with no further frequency dependence. However, in alternative embodiments of the invention, the step size and/or the overall temporal derivative determined for (second or third) frequency sub-range may each have a further frequency dependence (within the respective frequency sub-range). In particular, in certain embodiments of the invention, the captured sound signal is split into multiple frequency band signals so that the second frequency sub-range and, if defined, the third frequency sub-range each comprise a plurality of the frequency band signals. In this case, preferably, the step size and/or an overall temporal derivative may be defined as a frequency dependent quantity (e.g., as a vector) containing a value for each frequency band signal within the respective (second or third) frequency sub-range. Herein, the predefined onset criterion may be defined to be fulfilled when for all frequency band signals comprised in the respective (second or third) frequency sub-range,
a step of the signal level or signal energy having a step size exceeding a predefined first threshold is detected, and/or
a temporal derivative of the signal strength or signal energy exceeds a predefined second threshold; herein, again, an analysis as taught in European patent application EP 3 823 306 A1 may be applied.

As an alternative, the predefined onset criterion may be defined to be fulfilled when this condition is met for one or more selected frequency band signals comprised in the respective (second or third) frequency sub-range or for at least a predefined part (percentage) of the frequency band signals comprised in the respective (second or third) frequency sub-range, e.g., for at least 80% of the frequency band signals.

In preferred embodiments of the method, in the onset recognition step, the captured sound signal is analyzed to selectively recognize onsets of spoken phonemes of at least one predefined phoneme type. Herein, the first frequency sub-range corresponds to a characteristic frequency range of the respective phoneme type. Thus, upon recognition of a spoken phoneme of the predefined phoneme type, the signal level of the processed sound signal is momentarily increased only in the frequency sub-range that is characteristic for the respective phoneme type. For instance, the predefined phoneme type may be one of:
fricatives (“s”, “z”, “f”, “v”, etc.) having characteristic frequencies in a range between 4 kHz and 8 kHz,
affricates (“ds”, “pf”, “tsh”, etc.) having characteristic frequencies in a range between 3 kHz and 6 kHz,
plosives (“p”, “b”, “t”, “d”, “k”, “g”, etc.) having characteristic frequencies in a range between 2 kHz and 3.5 kHz,
liquids (“l”, “r”, etc.) having characteristic frequencies in a range between 1.5 kHz and 3 kHz,
nasals (“m”, “n”, etc.) having characteristic frequencies in a range between 1 kHz and 2 kHz,
etc.

Within the scope of the invention, the predefined phoneme type may be defined in greater detail; e.g. phoneme recognition may be sensitive and selective for a certain kind of fricatives (e.g., sibilants, non-sibilants, epiglottals, etc.). In other embodiments of the invention, the predefined phoneme type may be defined more coarse-grained; e.g., one phoneme type containing nasals and liquids may be predefined.

Moreover, within the scope of the invention, a plurality of different phoneme types may be predefined in parallel such that onsets of different phonemes are distinguished and attributed to the respective predefined phoneme type. In this case, preferably, onset enhancement is performed differently for each predefined phoneme type. In particular, a different first frequency sub-range is provided for each predefined phoneme type (corresponding to the characteristic frequency range of the respective phoneme type). Thus, for instance,
upon detection of an onset of a fricative, the signal level of the processed sound signal is momentarily and selectively increased in a frequency sub-range of 4 kHz and 8 kH,
while, upon detection of an onset of a nasal, the signal level of the processed sound signal is momentarily and selectively increased in a frequency sub-range of 1 kHz and 2 kH.

In addition or as an alternative, in an optional implementation of the phoneme recognition step, the second frequency sub-range and, if predefined, the third frequency sub-range may be adapted to the characteristic frequency range of the respective recognized phoneme type.

Preferably, in addition and parallel to the onset recognition step, at least one further algorithm for recognition of the phoneme type is applied to the captured sound signal. In this case, an onset of a spoken phoneme of a predefined phoneme type is only deemed recognized if the onset and (by the further algorithm) the phoneme type are recognized independently. For instance, in a simple but fast implementation of such algorithm, fricatives are recognized by testing whether the signal level of the captured sound signal at low frequencies (<2 kHz) undershoots a predefined low frequency threshold and testing whether the signal level of the captured sound signal at high frequencies (>4 kHz) exceeds a predefined high frequency threshold. Fricatives are recognized if both conditions are met, i.e., if both tests yield a positive result. Further algorithms that can be used for phoneme type detection, within the scope of the invention, are disclosed in
P1: M. Yurt, A. N. Escalante B., V. I. Morgenshtern: “Fricative Phoneme Detection with Zero Delay”, ICLR 2020 Conference Blind Submission, 25 Sep. 2019 (modified: 5 May 2023); to download (17.01.2025): https://openreview. net/attachment?id=BJxlmeBKwS&name=original_pdf.
P2: M. Yurt, et al., “Fricative Phoneme Detection using Deep Neural Networks and its Comparison to Traditional Methods”, Interspeech 2021, DOI: 10.21437/Interspeech.2021-645; to download (17.01.2025): https://www.isca-archive.org/interspeech_2021/yurt21_interspeech.pdf
P3: C. Glackin, et al., “Convolutional Neural Networks for Phoneme Recognition”, Int. Conf. on Pattern Recognition Applications and Methods 2018, DOI:10.5220/0006653001900195; to download (17.01.2025): https://pdfs.semanticscholar.org/ec9b/404281ce4c3b6a5acde48ba0ec533da0a7e3.pdf.

In a further preferred embodiment of the method, an onset strength is determined in the onset recognition step for each recognized onset. In the onset enhancement step, this onset strength is used to adjust a strength of the momentary increase of the signal level of the processed sound signal in the first frequency sub-range (enhancement strength). More precisely, the enhancement strength is varied inversely to the onset strength; i.e. for strong onsets less momentary increase of amplification is applied than for weak onsets. This helps to improve the sound quality as it limits the onset enhancement to the necessary extent. Phonemes with strong onsets can be understood comparably easily and, thus, require less enhancement than weak onsets. In an alternative embodiment, the enhancement strength is varied in dependence of the difference of the onset strength from a predefined expected value. The expected value may be predefined specifically for a phoneme type (and, thus differently for different phoneme types).

Within the scope of the invention, the onset strength can be determined as a global quantity for the entire second frequency sub-range without further frequency dependence. As an alternative, if the second frequency sub-range is split into a plurality of frequency band signals, the onset strength can be determined as a frequency-dependent quantity (in particular as a vector) having a value for each frequency band signal within the second frequency sub-range. In the latter case, optionally, the enhancement strength is varied individually for each frequency band signal within the first frequency sub-range, inversely to the spectrally corresponding value of the onset strength. In an appropriate implementation, the onset strength is determined from a step size of the step of the signal level or signal energy of the captured sound signal in the second frequency sub-range that is caused by the recognized onset of the spoken phoneme. If the second frequency sub-range is split into a plurality of frequency band signals, then the onset strength is determined from the step size of the step of the signal level or signal energy in at least one frequency band signal.

In a further embodiment, in the onset enhancement step, the enhancement strength is varied in dependence of an offset time, the offset time corresponding to a time interval between the recognized onset to be enhanced and an (immediately) preceding spoken phoneme, in particular the offset thereof. Herein and subsequently, the term “offset” denotes the temporal end point of a spoken phoneme. In the captured sound signal, the signature of the offset is a decrease of signal level following the onset, terminating the spoken phoneme. Preferably, within this method, such offsets are detected in parallel to onsets. In an alternative implementation, the offset time can be defined as being identical to or otherwise derived from the time interval between the recognized onset to be enhanced and the latest onset recognized before in which case a separate detection of offsets is not necessary. Varying the enhancement strength in dependence of the offset time also helps to improve the sound quality as it limits the onset enhancement to the necessary extent. In particular, the enhancement strength is increased inversely to the preceding offset time. Thus, recognized onsets are enhanced more strongly for short offset times than for long offset times. This considers the finding that spoken phonemes can be understood more easily if they occur in isolation, i.e. with a long temporal distance to the directly preceding phoneme. In contrast, a phoneme is harder to understand (and, thus, needs stronger enhancement to be understood) if it follows closely to a preceding phoneme.

In simple implementations, within the scope of the invention, the method can be executed independently of whether or not the captured sound signal contains speech. In such implementations, the method will improve speech intelligibility whenever there is speech. In non-speech intervals (in which the captured sound signal does not include speech) the method will run idle as, ideally, no onsets of spoken phonemes will be recognized. However, if the onset recognition step is performed during non-speech intervals also, this may lead to an increased rate of falsely recognized onsets leading to suboptimal sound quality. Thus, in more refined implementations of the method, the onset enhancement step (and, preferably, the onset recognition step) are performed in speech intervals only, i.e., in time intervals in which the captured sound signal contains speech. Herein, the presence of speech is detected by analyzing the captured sound signal, i.e., by applying a voice recognition algorithm to the captured sound signal. Preferably, the voice recognition algorithm is configured to distinguish the own voice of the user of the hearing instrument from foreign voice (i.e. voice of a speaker different from the user). In this case, preferably, the onset enhancement step (and, preferably, the onset recognition step) are performed in foreign speech intervals only, i.e., in time intervals in which the captured sound signal contains speech of a speaker different from the user.

In a further preferred embodiment of the invention, the enhancement strength and/or the enhancement time are individually selected for the user, in particular in dependence of at least one user property, e.g., a type of hearing impairment, a level of hearing impairment, a speech perception capability and/or audiogram data of the user. This allows for optimizing the benefit of the method to the individual user.

According to a second aspect of the invention, a hearing system with a hearing instrument (as previously specified) is provided. Preferred embodiments of the hearing system are defined in the dependent claims and in the subsequent description.

The hearing instrument contains:
an input transducer configured to capture an (original) sound signal from an environment of the hearing instrument,
a signal processor configured to process the captured sound signal to support the hearing of the user (in particular to at least partially compensate the hearing-impairment of the user), thus providing a processed sound signal, and an output transducer configured to emit the processed sound signal to the user.

In particular, the input transducer converts the original sound signal into an input audio signal (containing information on the captured sound) that is fed to the signal processor, and the signal processor outputs an output audio signal (containing information on the processed sound) to the output transducer which converts the output audio signal into air-borne sound, structure-borne sound or into a signal directly stimulating the auditory nerve.

In general, the hearing system according to the second aspect of the invention is configured to automatically perform the method according to the first aspect of the invention. To this end, the hearing system comprises:
an onset recognition module configured to analyze the captured sound signal to recognize onsets of spoken phonemes, and
an onset enhancement module configured to momentarily modify the processed sound signal, when an onset of a spoken phoneme is recognized, to enhance the onset.

Herein, according to the invention, the onset enhancement module is configured to momentarily modify the processed sound signal by selectively increasing the signal level of the processed sound signal in a first frequency sub-range.

For each embodiment or variant of the method according to the first aspect of the invention there is a corresponding embodiment or variant of the hearing system according to the second aspect of the invention. Thus, disclosure related to the method also applies, mutatis mutandis, to the hearing system, and vice-versa.

In particular, in preferred embodiments of the hearing system, for recognition of onsets of spoken phonemes, the onset recognition module is configured to selectively analyze the captured sound signal in a second frequency sub-range for fulfilling a predefined onset criterion; in addition, optionally, the onset recognition module is configured to selectively analyze the captured sound signal in a third frequency sub-range for non-fulfillment of the predefined onset criterion, wherein the third frequency sub-range does not overlap with the second frequency sub-range; in both cases, preferably, the predefined onset criterion is fulfilled when, for the respective frequency sub-range (or frequency bands signals comprised therein), a step of the signal level or signal energy having a step size exceeding a predefined threshold is detected, and/or a temporal derivative of the signal strength or signal energy exceeds a predefined threshold; in a preferred implementation, the step size is derived from a difference of a short-time average and a long-time average of the respective signal level or signal energy.

The onset recognition module is configured to analyze the captured sound signal to selectively recognize onsets of spoken phonemes of at least one predefined phoneme type, and wherein the first frequency sub-range corresponds to a characteristic frequency range of the respective phoneme type.

The onset recognition module is configured to determine an onset strength for each recognized onset, and the onset enhancement module is configured to vary the enhancement strength (as defined above) inversely to the onset strength; preferably, the onset strength is determined from a step size of a step of the signal level or signal energy of the captured sound signal in the second frequency sub-range or at least one frequency band signal comprised in the second frequency sub-range.

The onset enhancement module is configured to vary the enhancement strength in dependence of an offset time, the offset time corresponding to a time interval between the recognized onset to be enhanced and an (immediately) preceding spoken phoneme, in particular the offset thereof.

The system further comprises a voice recognition module configured to analyze the captured sound signal to recognize speech intervals, in particular foreign speech intervals, wherein the onset enhancement module is configured to momentarily modify the processed sound signal upon recognition of an onset of a spoken phoneme during such speech intervals only; and/or the onset enhancement module is configured to individually select (and adjust) the enhancement strength and/or the enhancement time for the user, in particular in dependence of at least one user property, e.g. a type of hearing impairment, a level of hearing impairment, a speech perception capability and/or audiogram data of the user.

Preferably, the signal processor is designed as a digital electronic device. It may be a single module or consist of a plurality of sub-processors. The signal processor or at least one of the sub-processors may be a programmable device (e.g., a microcontroller). In this case, the functionality mentioned above, or part of the functionality is implemented as software (firmware). Also, the signal processor or at least one of the sub-processors may be a non-programmable device (e.g., an ASIC). In this case, the functionality mentioned above, or part of the functionality may be implemented as hardware circuitry.

In a preferred embodiment of the invention, the onset recognition module, the onset enhancement module and/or the voice recognition module are arranged in the hearing instrument. In particular, each of these modules may be designed as a hardware or software component of the signal processor or as separate electronic component. However, in other embodiments of the invention, the onset recognition module, the onset enhancement module, the voice recognition module or at least a functional part thereof may be located on an external electronic device such as a second hearing instrument of the hearing system or a mobile phone.

Other features which are considered as characteristic for the invention are set forth in the appended claims.

Although the invention is illustrated and described herein as embodied in a hearing system containing a hearing instrument and a method for operating the hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration of a hearing system containing a hearing instrument to be worn at the ear of a user, wherein the hearing instrument comprises two input transducers arranged to capture a sound signal from an environment of the hearing instrument, a signal processor arranged to process the captured sound signal, and an output transducer arranged to emit the processed sound signal to the user, wherein an onset recognition module and an onset enhancement module are implemented in the signal processor;

FIG. 2 is a schematic block diagram of a functional structure of a first embodiment of the hearing system of FIG. 1;

FIG. 3 is a graph showing, in two schematic synchronous diagrams over time, an exemplary temporal course of a frequency band signal containing information on an onset and an offset of a spoken phoneme, and two sliding temporal averages of the frequency band signal (upper diagram), and the difference of the two averages (lower diagram);

FIG. 4 is a graph showing, in a schematic diagram over time, a momentary gain (enhancement gain) applied by the onset enhancement module to the processed sound signal when the onset recognition module recognizes an onset of a spoken phoneme in the captured sound signal;

FIG. 5 is a schematic block diagram corresponding to FIG. 2, of a functional structure of a further embodiment of the hearing system of FIG. 1;

FIG. 6 is a diagram of a functional dependency of an enhancement strength of an offset time corresponding to the time interval between a recognized onset to be enhanced and a preceding spoken phoneme;

FIG. 7 is a diagram of a functional dependence of the enhancement strength of an onset strength of a recognized onset to be enhanced; and

FIG. 8 is a schematic block diagram of the functional structure of another embodiment of the hearing system of FIG. 1.

Like reference numerals indicate like parts, structures and elements unless otherwise indicated.

### DETAILED DESCRIPTION OF THE INVENTION

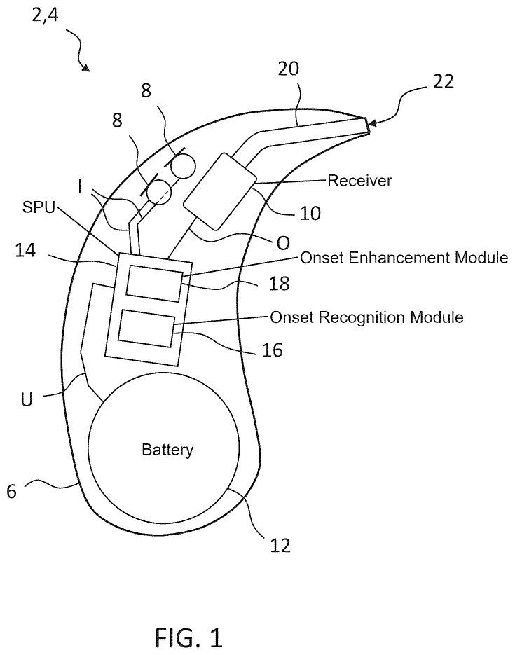

Referring now to the figures of the drawings in detail and first, particularly to FIG. 1 thereof, there is shown a hearing system 2 containing a hearing instrument 4 which, by way of example, may be configured as a Behind-The-Ear (BTE) device. In the preferred implementation, the hearing instrument 4 is a hearing aid that is configured to support the hearing of a hearing-impaired user. As shown in FIG. 1, the hearing system 2 may solely consist of the hearing instrument 4 and, thus, may not comprise any further device or structure. However, optionally, the hearing system 2 may comprise at least one further device such a second hearing instrument (not shown) to be worn in or at the other ear of the user to provide binaural support to the user. Alternatively, or additionally, the hearing system 2 may comprise a structure such as an app for remote control and/or configuration of the hearing instrument 4 being installed, e.g., on a smartphone of the user.

The hearing instrument 4 contains a housing 6 that is configured to be worn in or at one of the ears of the user. Inside that housing 6, the hearing instrument 4 comprises two microphones 8 as input transducers and a receiver 10 as output transducer. The hearing instrument 4 further contains a battery 12 and a signal processor 14. Preferably, signal processor 14 comprises both a programmable sub-unit (such as a microprocessor) and a non-programmable sub-unit (such as an ASIC). In the signal processor 14, i.e., an onset recognition module 16 and an onset enhancement module 18 are implemented. By preference, both modules 16 and 18 are designed as software components being installed in the signal processor 14. However, any one of these modules 16 and 18 can also be implemented as a hardware circuitry such an ASIC or functional part thereof. The signal processor 14 is powered by battery 12, i.e., the battery 12 provides an electrical supply voltage U to the signal processor 14.

During normal operation of the hearing instrument 4, the microphones 8 capture a sound signal from an environment of the hearing instrument 4. The microphones 8 convert the sound into an input audio signal I, containing information on the captured sound. The input audio signal I is fed to the signal processor 14. The signal processor 14 processes the input audio signal I, i.e., to provide directed sound information (beamforming), to perform noise reduction and/or dynamic compression. Moreover, if the hearing instrument 4 is designed as a hearing aid, the signal processor 14 is configured to individually amplify different spectral portions of the input audio signal I based on audiogram data of the user to compensate the user-specific hearing loss.

The signal processor 14 emits an output audio signal O containing information on the processed sound to the receiver 10. The receiver 10 converts the output audio signal O into processed air-borne sound that is emitted into the ear canal of the user, via a sound channel 20 connecting the receiver 10 to a tip 22 of the housing 6 and a flexible sound tube (not shown) connecting the tip 22 to an ear piece inserted in the ear canal of the user.

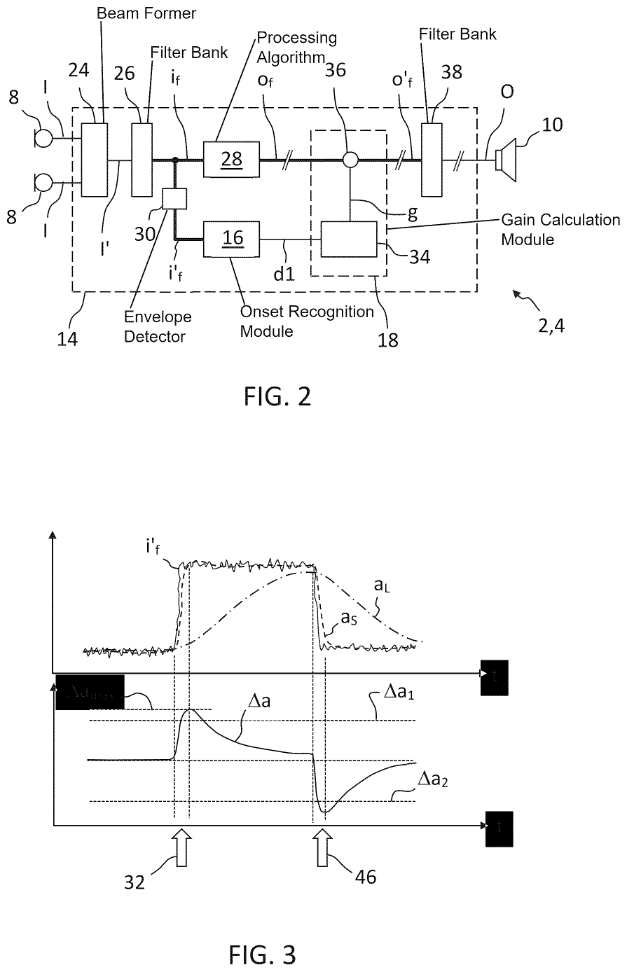

FIG. 2 shows a functional structure of the signal processor 14 in more detail. As can be seen herein, the input audio signal I of the two microphones 8 is fed to a beam former 24 that outputs a beamformed input audio signal I′ to an analysis filter bank 26. The analysis filter bank 26 converts the beamformed input audio signal I′ into a frequency domain representation of this signal in that it spectrally splits the beamformed input audio signal I′ into a plurality of (e.g. 128) frequency band signals i_{f} each of which contains a spectral portion of the beamformed input audio signal I′ corresponding to a small frequency range with a center frequency.

At least one data processing algorithm 28 (as previously described) is applied to frequency band signals i_{f} to modify the input audio signal I and, thus, support the hearing of the user. The at least one data processing algorithm 28 outputs a frequency representation of the processed audio signal O containing processed frequency band signals o_{f}. The processed frequency band signals o_{f} are fed to the onset enhancement module 18.

Parallel hereto, the frequency band signals i_{f} are fed to an envelope detector 30 that extracts the time-dependent signal level (envelope) of each of the frequency band signals i_{f}. The envelope detector 30 outputs frequency band signals i′_{f} containing the signal levels to the onset recognition module 16.

In order to recognize onsets of spoken phonemes, the onset recognition module 16 selectively analyzes a sub-set of the frequency band signals i′_{f} corresponding to a (second) frequency sub-range for fulfilling a predefined onset criterion. In an appropriate implementation, being specifically configurated to recognize onsets of spoken fricatives, the (second) frequency sub-range extends from 4 kHz to 8 kHz. In this case, thus, the onset recognition module 16 checks only frequency band signals i′_{f} with center frequencies between 4 kHz to 8 kHz for fulfilling the onset criterion. In this analysis, the onset recognition module 16 determines a sliding short-time average a_{S} and sliding long-time average a_{L} for each of the frequency band signals i′_{f} within the (second) frequency sub-range, wherein the short-time average a_{S} is calculated for a time window (averaging time) of 10 msec, whereas the long-time average a_{L} is calculated for a time window of 125 msec.

The onset recognition module 16 herein compares the two averages a_{S} and a_{L} by determining the difference Δa thereof (Δa=a_{S}−a_{L}). In a simple implementation, the onset criterion is fulfilled and, thus, an onset is recognized by the onset recognition module 16 if for all frequency band signals i′_{f} within the (second) frequency sub-range the difference Δa exceeds a predefined threshold Δa₁, i.e. if the short-time average a_{S} exceeds the long-time average a_{L} by more than the predefined threshold Δa₁. This is illustrated in FIG. 3 in two synchronous diagrams showing one of the frequency band signals i′_{f} within the (second) frequency sub-range, its short-time average a_{S} and its long-time average a_{L} and the difference Δa over time t. Herein, the point of time at which the onset criterion is fulfilled, for this frequency band signal i′_{f}, is marked with an arrow 32.

In addition, optionally, onsets may be recognized by analyzing temporal derivatives of the frequency band signals i′_{f} as, per se, taught by published, European patent application EP 3 823 306 A1. In this case, an onset is recognized only if both the difference Δa and the derivatives fulfill a respective onset criterion.

When the onset recognition module 16 detects an onset of a spoken phoneme (as described above) it outputs an onset detection signal d1 to a gain calculation module 34 of the onset enhancement module 18. Upon receipt of the onset detection signal d1, the gain calculation module 34 calculates an additional enhancement gain g for each of a sub-set of the frequency band signals i_{f} corresponding to a (first) frequency sub-range. In the preferred implementation, the first frequency sub-range corresponds to the second frequency sub-range considered by the onset recognition module 16. Thus, in this example, the gain calculation module 34 calculates the additional enhancement gain g only for the frequency band signals o_{f} with center frequencies between 4 kHz to 8 kHz. The enhancement gains g are applied to the respective frequency band signals o_{f} by a multiplier 36 of the onset enhancement module 18.

Modified frequency band signals o′_{f} are output by the onset enhancement module 18 to a (synthesis) filter bank 38 that combines the frequency band signals o′_{f}, thereby creating the output audio signal O.

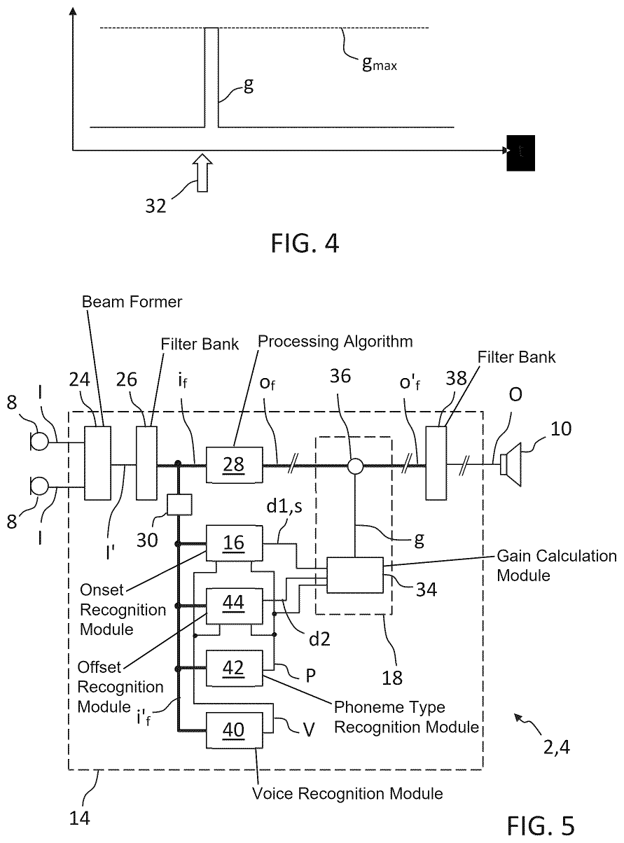

As illustrated in FIG. 4 for a frequency band signal o_{f} within the (first) frequency sub-range, the enhancement gains g are created with a limited duration between 5 to 15 msec, in particular ca 10 msec. Application of the enhancement gains g to the frequency band signals o_{f} comprised in the first frequency sub-band, thus, results in a momentary and spectrally selective increase of the signal level of these frequency band signals o_{f} that enhances the recognized onset in the output signal O.

In a most simple implementation of the hearing system 2, the predefined parameters of the method, i.e. the (first and second) frequency sub-ranges, the threshold Δa₁ as well as the duration of the enhancement (enhancement time) and maximum value of the enhancement gains g (enhancement strength) can be provided as constant values without further dependency from time, frequency or other conditions. However, in more refined versions of the method, these parameters may be provided with a frequency dependence (within the first or second frequency sub-range). Moreover, the threshold Δa₁ can be defined as a variable being dependent on at least one property of the sound environment such the signal-to-noise ration of the input audio signal I.

In a refined version of the hearing system 2 of FIG. 2, in addition to checking for fulfillment of the onset criterion for frequencies within the second frequency sub-range, the onset recognition module 16 also checks for non-fulfillment of the onset criterion in a third frequency sub-range outside the second frequency sub-range. In this case, the onset recognition module 16 is configured to recognize an onset of a spoken phoneme only if the onset criterion is fulfilled for all frequency band signals i′_{f} (or at least one selected frequency band signal i′_{f}) within the second frequency sub-range and not fulfilled for all frequency band signals i′_{f} (or at least one selected frequency band signal i′_{f}) within the third frequency sub-range.

Furthermore, different from the example shown in FIG. 4, the momentary increase of the enhancement gains g upon recognition of an onset may be created with a non-rectangular time dependence, i.e. with a continuous increase, and/or decrease in time, e.g. as shown in Published, European patent application EP 3 823 306 A1.

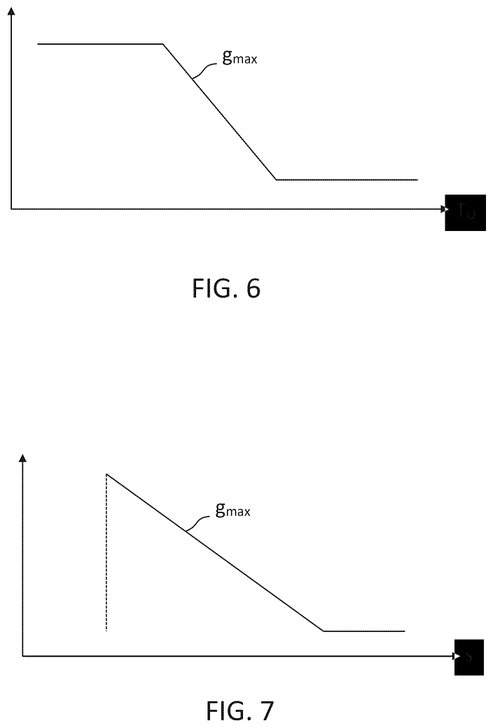

FIG. 5 shows a further embodiment of the hearing system 2 which, in addition to the components of the hearing system 2 according to FIG. 2, comprises a voice recognition module 40, a phoneme type recognition module 42 and an offset recognition module 44. By preference, these modules 40, 42, and 44 are implemented as software components being installed in the signal processor 14. However, any one of these modules 40, 42 and 44 can also be implemented as hardware circuitry such an ASIC or functional part thereof.

The voice recognition module 40 detects the presence of voice sounds in the input audio signal I by analyzing the frequency band signals i′_{f}. In detail, the voice recognition module 40 comprises a voice activity detector (VAD) that is designed to detect the presence of voice activity, independent of a specific speaker. In addition, the voice recognition module 40 comprises an own voice detector (OVD) that is designed to specifically detect the presence of the user's own voice. By preference, the VAD and the OVD apply technologies of voice activity detection and own voice detection, respectively that are as such known in the art, e.g., from U.S. patent publication No. 10,403,306 B 2 or internation patent publication WO 2016/078786 A1. By analyzing the frequency band signals i′_{f} (and, thus, the captured sound signal), the VAD and the OVD recognize “foreign speech intervals”, in which the input audio signal I contains “foreign speech”, i.e. speech of a speaker different from the user of the hearing instrument 4. During such “foreign speech intervals, i.e., whenever and as long as the voice recognition module 40 detects foreign speech in the input audio signal I, it outputs a (foreign) voice detection signal V (that indicates recognition of foreign speech in the input audio signal I).

The phoneme type recognition module 42 is configured to recognize and distinguish different predefined types of spoken phonemes in the captured sound signal I by analyzing the frequency band signals i′_{f}, e.g., using methods as disclosed in documents P1 to P3. Herein, whenever the phoneme type recognition module 42 detects one of the predefined phoneme types, the phoneme type recognition module 40 outputs a phoneme identification signal P (that indicates recognition of a spoken phoneme of a specific type in the input audio signal I).

Finally, the offset recognition module 44 is configured to recognize offsets (i.e., the temporal end points) of spoken phonemes in the captured sound signal I by analyzing the frequency band signals i′_{f} for fulfilling an offset criterion. The offset detection module 44 has a reverse function as compared to the onset recognition module 16; and, thus, the offset criterion may be defined reversely to the onset criterion. In a preferred implementation, the offset recognition module 44 compares the sliding short-time average a_{S} and the sliding long-time average a_{L} (as defined for the onset recognition module 16) for each of the frequency band signals i′_{f} within the (second) frequency sub-range and recognizes offsets whenever for all the frequency band signals i′f the difference of the averages Δa (having a negative value in case of offsets, see FIG. 3) falls below a predefined threshold Δa₂, i.e. if the short-time average a_{S} undershoots the long-time average a_{L} by more than the predefined threshold Δa₂. When the offset recognition module 44 detects an offset of a spoken phoneme (as described above) it outputs an offset detection signal d2 to the gain calculation module 34 of the onset enhancement module 18. In FIG. 3, the point of time at which the offset criterion is fulfilled, for this frequency band signal i′_{f}, is marked with an arrow 46. Like the onset recognition module 16, optionally, the offset recognition module 44 may check for non-fulfillment of the offset criterion in the third frequency sub-range as a further necessary condition for recognizing offsets.

The offset detection signal d2 is used by the onset enhancement module 18 to adjust the enhancement strength gₘₐₓ, i.e., the value or maximum value of the enhancement gains g (cf. FIG. 4). The gain calculation module 34 herein determines the time interval between each recognized onset to be enhanced and the latest recognized offset (offset time T_{O}). In particular, the gain calculation module 34 determines this offset time T_{O} by starting a timer upon receipt of the offset detection signal d2 which timer is stopped upon receipt of the next onset detection signal d1. In a preferred implementation, the gain calculation module 34 linearly varies the enhancement strength gₘₐₓ between a higher value and a lower value, whereas a higher value is adopted for low offset times T_{O} (e.g. T_{O}≤30 msec) and the lower value is adopted for high offset times T_{O} (e.g. T_{O}≥60 msec). The lower value of the enhancement strength gₘₐₓ may be set to 1 or close to 1 so that no or almost no onset enhancement is applied to onsets preceded by long offset time T_{O}.

The phoneme identification signal P is used by the onset recognition module 16, the offset recognition module 44 and the onset enhancement module 34 to adjust the phoneme enhancement to the type of the recognized phoneme (as indicated by the phoneme identification signal P). In particular, the onset recognition module 16 and the offset recognition module 44 select the second frequency sub-range such that it corresponds to the characteristic frequency range of the recognized phoneme type. Likewise, the gain calculation module 34 selects the first frequency sub-range such that it corresponds to the characteristic frequency range of the recognized phoneme type. Moreover, the gain calculation module 34 may be configured to modify the enhancement strength gₘₐₓ and/or the enhancement time in dependence of the phoneme identification signal P. Optionally, the onset recognition module 16 and the offset recognition module 44 are configured not to output the onset detection signal d1 and the offset detection signal d2, respectively, in absence of the phoneme type identification signal P. In this case, onsets of spoken phonemes are only enhanced if they can be attributed to one of the predefined phoneme types.

The voice detection signal V is used to activate phoneme recognition and phoneme enhancement in foreign voice intervals only. Thus, the onset recognition module 16 and the offset recognition module 44 are configured not to output the onset detection signal d1 and the offset detection signal d2, respectively, in absence of the (foreign) voice detection signal V.

The onset detection signal d1 may be defined as a binary signal that indicates recognition of an onset in a qualitative manner only. However, in an alternative implementation of the hearing system 2 according to FIG. 5, the onset detection signal d1 contains a quantitative information on the strength of a recognized onset (onset strength s). Preferably, the onset recognition module 16 derives this onset strength from the stepsize Δaₘₐₓ (i.e. a local maximum of the difference Δa, cf. FIG. 3) of the frequency band signals i′_{f} within the second frequency sub-range. For instance, the onset recognition module 16 may be configured to take the stepsize Δaₘₐₓ of one selected frequency band signal i′_{f} within the second frequency sub-range as the onset strength. As an alternative, the onset recognition module 16 may be configured to determine the onset strength s from a combination, particularly a weighted average, of the respective stepsize Δaₘₐₓ of a plurality of frequency band signals i′_{f} within the second frequency sub-range.

The gain calculation module 34 is configured to vary the enhancement strength gₘₐₓ inversely to the onset strength s. In the preferred implementation, as shown in FIG. 7, the gain calculation module 34 decreases the enhancement strength gₘₐₓ inversely to the onset strength s. Thus, strong onsets are enhanced less strongly than weak onsets. For extraordinarily strong onsets, the enhancement strength is reduced to 1; thus, no enhancement is applied to such onsets. On the other hand, the onset strength s has a lower limit as weaker onsets are not recognized by the onset recognition module 16.

Different from the implementations described above, functional parts of the hearing system 2 such as the onset recognition module 16, the offset recognition module 44, the voice recognition module 40 and/or the phoneme type recognition module 42, can be implemented outside the hearing instrument, if available, e.g. in an app of the hearing system 2 that is installed in and runs on a smartphone of the user.

In preferred embodiments of the hearing system 2, the enhancement strength and/or the enhancement time can be adapted to the requirements of the individual user. This feature takes account of the finding that hearing loss typically is a combination of threshold loss, frequency discrimination loss and temporal precision loss. Whereas normal hearing aid algorithms compensate (directly or indirectly) for the threshold loss only, the onset enhancement method described above has the potential of compensating for both the thresholds and the temporal precision loss. Individual adaptation (fitting) of the onset enhancement can be done by taking into account either one or both the hearing loss and the temporal precision loss of the individual.

In order to find appropriate settings of the enhancement strength gₘₐₓ and/or the enhancement time for the individual user, in a most simple implementation, the user may be provided with one or more control elements, e.g. on a user interface of an app of hearing system 2, by means of which the user can adjust the enhancement strength gₘₐₓ and/or the enhancement time as desired, during normal operation of the hearing system 2.

In a modified procedure, the user may be given the opportunity to adjust the enhancement strength gₘₐₓ and/or enhancement time while hearing recordings of a selected logatomes such as “assa”, “ascha”, “esse”, “esche”, etc. Such logatomes may be played at a different level and with a different signal-to-noise ratio (SNR). For each logatome (representing a phoneme type) and each level and/or SNR, the settings selected by the user are stored and re-used later in similar situations during operation of the hearing system 2.

In a further variation of the fitting procedure, the user is provided with samples of the same logatome or word with more or less enhanced onsets, between which the user can chose. The enhancement strength and/or the enhancement time are then selected in accordance with the user's selection.

Furthermore, adaptation of the enhancement strength and/or the enhancement time can be made based on known psychoacoustic test and/or fitting methods, e.g., the fitting method described in published, European patent application EP 4 287 655 A1. Also, at least one further user property, e.g., a type or level of the user's hearing impairment and/or audiogram data may be used to individually adjust enhancement strength and/or the enhancement time.

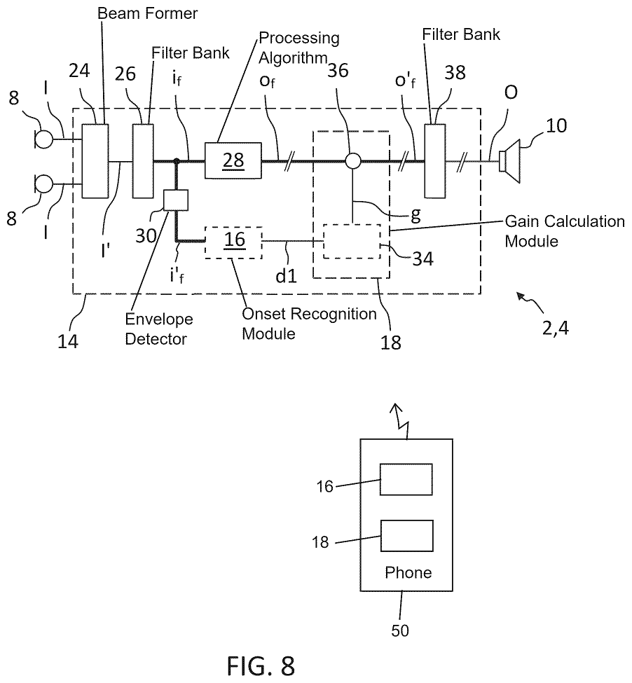

FIG. 8 shows another embodiment of the hearing system. In FIG. 8, the onset recognition module 16 and the onset enhancement module 18 are now located in an external electronic device such as a mobile phone 50 rather than in the hearing instrument 4.

It will be appreciated by persons skilled in the art that numerous variations and/or modifications may be made to the invention as shown in the specific examples without departing from the spirit and scope of the invention as broadly described in the claims. The present examples are, therefore, to be considered in all aspects as illustrative and not restrictive. Unless specified otherwise or excluded for causal reasons, all elements of the embodiments described above can be used in different combinations, in accordance with the subject matter of the claims, without departing from the scope of the invention.

The following is a summary list of reference numerals and the corresponding structure used in the above description of the invention:
2 hearing system
4 hearing instrument
6 housing
8 microphone
10 receiver
12 battery
14 signal processor
16 onset recognition module
18 onset enhancement module
20 sound channel
22 tip
24 beam former
26 (analysis) filter bank
28 data processing algorithm
30 envelope detector
32 arrow
34 gain calculation module
36 multiplier
38 (synthesis) filter bank
40 voice recognition module
42 phoneme type recognition module
44 offset recognition module
46 arrow
50 mobile phone
Δa difference
Δa₁ threshold
Δa₂ threshold
Δaₘₐₓ step size
a_{L} (long-time) average
a_{S} (short-time) average
d1 onset detection signal
d2 offset detection signal
g enhancement gain
gₘₐₓ enhancement strength
i_{f} frequency band signal
i′_{f} frequency band signal
o_{f} frequency band signals
o′_{f} frequency band signals
s onset strength
t time
I input audio signal
I′ (beamformed) input audio signal
O output audio signal
P phoneme type identification signal
T_{O} offset time
U (supply) voltage
V (foreign) voice detection signal

1. A method for operating a hearing instrument configured to be worn in or at an ear of a user, the method comprises the following steps of:
capturing a sound signal from an environment of the hearing instrument;
processing a captured sound signal to support a hearing of the user, processing of the captured sound signal with the following sub-steps of:
performing an onset recognition step in which the captured sound signal is analyzed to recognize onsets of spoken phonemes; and
performing an onset enhancement step by momentarily modifying a processed sound signal, when an onset of a spoken phoneme is recognized, to enhance the onset, the processed sound signal is momentarily modified by selectively increasing a signal level of the processed sound signal in a first frequency sub-range; and
outputting the processed sound signal to the user.

2. The method according to claim 1, wherein, in the onset recognition step, recognition of the onsets of spoken phonemes involves selectively analyzing the captured sound signal in a second frequency sub-range for fulfilling a predefined onset criterion, the second frequency sub-range being identical or similar to the first frequency sub-range.

3. The method according to claim 2, wherein, in the onset recognition step, recognition of the onsets of the spoken phonemes involves selectively analyzing the captured sound signal in a third frequency sub-range for non-fulfillment of the predefined onset criterion, wherein the third frequency sub-range does not overlap with the second frequency sub-range.

4. The method according to claim 2, wherein the predefined onset criterion is fulfilled when, for a respective one of the first and second frequency sub-ranges:
a step size of a step of the signal level or signal energy exceeds a predefined threshold; and/or
a temporal derivative of a signal strength or the signal energy exceeds the predefined threshold.

5. The method according to claim 1, wherein, in the onset recognition step, the captured sound signal is analyzed to selectively recognize the onsets of the spoken phonemes of at least one predefined phoneme type, and wherein the first frequency sub-range corresponds to a characteristic frequency range of a respective phoneme type.

6. The method according to claim 2, wherein:
in the onset recognition step, an onset strength is determined for each recognized onset; and
in the onset enhancement step, a strength of the momentary increase of the signal level of the processed sound signal in the first frequency sub-range is varied inversely to the onset strength.

7. The method according to claim 6, wherein the onset strength is determined from a step size of a step of the signal level or signal energy of the captured sound signal in the second frequency sub-range or of at least one frequency band signal contained in the second frequency sub-range.

8. The method according to claim 1, wherein, in the onset enhancement step, a strength of the momentary increase of the signal level of the processed sound signal in the first frequency sub-range is varied in dependence on an offset time, the offset time corresponding to a time interval between a recognized onset to be enhanced and a preceding spoken phoneme.

9. The method according to claim 1, which further comprises analyzing the captured sound signal to recognize speech intervals, in which the captured sound signal contains speech, namely speech of a speaker different from the user of the hearing instrument, and wherein the onset enhancement step is executed during only the speech intervals.

10. The method according to claim 1, wherein a strength and/or a duration of the momentary increase of the signal level of the processed sound signal in the first frequency sub-range is individually selected for the user.

11. A hearing system, comprising:
a hearing instrument to be worn in or at an ear of a user, said hearing instrument containing:
an input transducer configured to capture a sound signal from an environment of the hearing instrument;
a signal processor configured to process a captured sound signal to support hearing of the user; and
an output transducer configured to emit the processed sound signal to the user;
the hearing system further comprising:
an onset recognition module configured to analyze the captured sound signal to recognize onsets of spoken phonemes; and
an onset enhancement module configured to momentarily modify a processed sound signal, when an onset of a spoken phoneme is recognized, to enhance the onset, said onset enhancement module configured to momentarily modify the processed sound signal by selectively increasing a signal level of the processed sound signal in a first frequency sub-range.

12. The hearing system according to claim 11, wherein, for recognition of the onsets of the spoken phonemes, said onset recognition module is configured to selectively analyze the captured sound signal in a second frequency sub-range for fulfilling a predefined onset criterion.

13. The hearing system according to claim 12, wherein, for recognition of the onsets of the spoken phonemes, said onset recognition module is configured to selectively analyze the captured sound signal in a third frequency sub-range for non-fulfillment of the predefined onset criterion, wherein the third frequency sub-range does not overlap with the second frequency sub-range.

14. The hearing system according to claim 12, wherein the predefined onset criterion is fulfilled when, for a respective one of the first and second frequency sub-ranges:
a step size of a step of the signal level or signal energy exceeds a predefined threshold; and/or
a temporal derivative of a signal strength or the signal energy exceeds the predefined threshold.

15. The hearing system according to claim 11, wherein said onset recognition module is configured to analyze the captured sound signal to selectively recognize the onsets of the spoken phonemes of at least one predefined phoneme type, and wherein the first frequency sub-range corresponds to a characteristic frequency range of a respective phoneme type.

16. The hearing system according to claim 12, wherein:
said onset recognition module is configured to determine an onset strength for each recognized onset; and
said onset enhancement module is configured to vary a strength of the momentary increase of the signal level of the processed sound signal in the first frequency sub-range inversely to the onset strength.

17. The hearing system according to claim 16, wherein the onset strength is determined from a step size of a step of the signal level or signal energy of the captured sound signal in the second frequency sub-range or of at least one frequency band signal contained in the second frequency sub-range.

18. The hearing system according to claim 11, wherein said onset enhancement module is configured to vary a strength of the momentary increase of the signal level of the processed sound signal in the first frequency sub-range in dependence of an offset time, the offset time corresponding to a time interval between a recognized onset to be enhanced and a preceding spoken phoneme.

19. The hearing system according to claim 11, further comprising a voice recognition module configured to analyze the captured sound signal to recognize speech intervals in which the captured sound signal contains speech, and wherein said onset enhancement module is configured to momentarily modify the processed sound signal upon recognition of an onset of a spoken phoneme during only the speech intervals.

20. The hearing system according to claim 11, wherein said onset enhancement module is configured to individually select a strength and/or a duration of the momentary increase of the signal level of the processed sound signal in the first frequency sub-range for the user, in dependence of at least one user property from the group consisting of: a type of hearing impairment, a level of hearing impairment, a speech perception capability and an audiogram data.
